(19) United States
(12) Patent Application Publication
(10) Pub. No.: US 2013/0215046 A1
(43) Pub. Date: Aug. 22, 2013

(54) MOBILE PHONE, STORAGE MEDIUM AND METHOD FOR EDITING TEXT USING THE MOBILE PHONE

(71) Applicant: YU-HUA HUNG, Tu-Cheng (TW)

(72) Inventor: YU-HUA HUNG, Tu-Cheng (TW)

(73) Assignee: CHI MEI COMMUNICATION SYSTEMS, INC., Tu-Cheng (TW)

(21) Appl. No.: 13/533,992

(22) Filed: Jun. 27, 2012

(30) Foreign Application Priority Data
Feb. 16, 2012 (TW) 101105015

(51) Int. Cl. G06F 3/041

(52) U.S. Cl. 345/173

(57) ABSTRACT

In a method for editing text using a mobile phone, a user via a touch screen of the mobile phone selects a target text displayed on the touch screen. Handwritten data input by the user via the touch screen is recognized by a handwriting recognition system of the mobile phone. A predetermined editing operation corresponding to the handwritten data is performed on the target text. The editing operation is a cut operation, a copy operation, or a paste operation.

### BACKGROUND

1. Technical Field

Embodiments of the present disclosure relate to data processing devices and methods, and more particularly to a mobile phone, a storage medium, and a method for editing text using the mobile phone.

2. Description of Related Art

A mobile phone can display a text of a web page, a calendar, or a text file on a display screen of the mobile phone. Usually, users can perform editing operations, such as cut, copy, and paste operations on the text displayed by the mobile phone via editing options of the mobile phone. However, for example, if a user wants to copy a target text, the user has to select the target text via a keyboard or a touch screen of the mobile phone, search for a “copy” option in menus of the mobile phone, and select the “copy” option in order to copy the target text. It is inconvenient for the user to find desired editing options if the user is not familiar with navigation of the editing options.

### BRIEF DESCRIPTION OF THE DRAWINGS

FIG. 1 is a block diagram of one embodiment of a mobile phone including a text editing system.

FIG. 2 is a block diagram of one embodiment of functional modules of the text editing system included in the mobile phone of FIG. 1.

FIG. 3 is a flowchart of one embodiment of a method for editing text using the mobile phone of FIG. 1.

FIGS. 4-7 are schematic diagrams illustrating examples of text editing operations using the mobile phone of FIG. 1.

FIG. 8 is a flowchart illustrating an example of the text editing operations corresponding to FIGS. 4-7.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, BLU-RAY, flash memory, and hard disk drives.

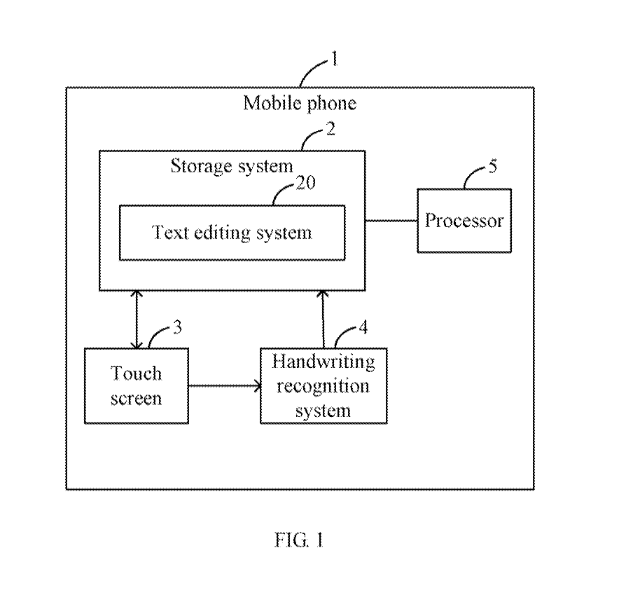

FIG. 1 is a block diagram of one embodiment of a mobile phone 1 including a text editing system 20. In the embodiment, the mobile phone 1 further includes a storage system 2, a touch screen 3, a handwriting recognition system 4, and at least one processor 5. FIG. 1 is just one example of the mobile phone 1 that can be included with more or fewer components than shown in other embodiments, or have a different configuration of the various components.

The touch screen 3 can display data of the mobile phone 1. The handwriting recognition system 4 recognizes handwritten data, such as letters or numbers input by a user via the touch screen 3. The text editing system 20 may be in form of one or more programs that are stored in the storage system 2 and executed by the at least one processor 5. In one embodiment, the user inputs predetermined editing commands, such as cut, copy, and paste commands to the touch screen 3 when the text displayed on the touch screen 3 is in an editable state. The handwriting recognition system 4 recognizes the input editing commands, and the text editing system 20 performs editing operations corresponding to the recognized editing commands on the text displayed on the touch screen 3.

In one embodiment, the storage system 2 may be a random access memory (RAM) for temporary storage of information, and/or a read only memory (ROM) for permanent storage of information. In other embodiments, the storage system 2 may also be an external storage device, such as a storage card or a data storage medium. The at least one processor 5 executes computerized operations of the mobile phone 1 and other applications to provide functions of the mobile phone 1.

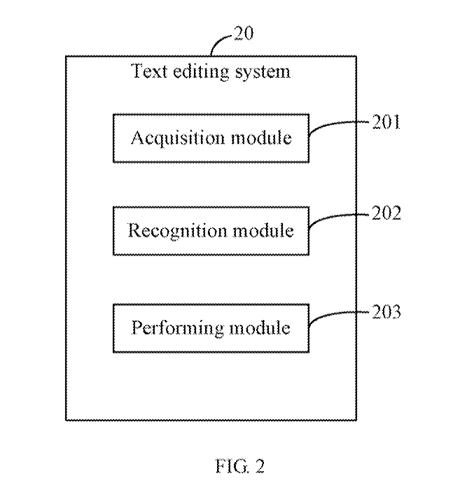

FIG. 2 is a block diagram of one embodiment of functional modules of the text editing system 20 included in the mobile phone 1 of FIG. 1. In one embodiment, the text editing system 20 may include an acquisition module 201, a recognition module 202, and a performing module 203. The modules 201-203 may comprise a plurality of functional modules each comprising one or more programs or computerized codes that are stored in the storage system 2, and can be accessed and executed by the at least one processor 5. A detailed description of each module will be given in the following paragraphs.

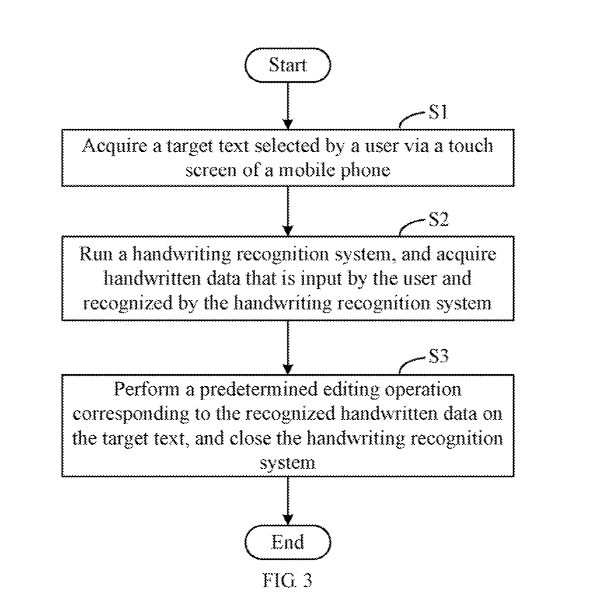

FIG. 3 is a flowchart of one embodiment of a method for editing text using the mobile phone 1 of FIG. 1. Depending on the embodiment, additional steps may be added, others removed, and the ordering of the steps may be changed.

In step S1, the acquisition module 201 acquires a target text displayed on the touch screen 3 and selected by the user via the touch screen 3. The target text may be selected or cut from the text displayed on the touch screen 3, or the target text may be duplicate text acquired by copying an original text displayed on the touch screen 3.

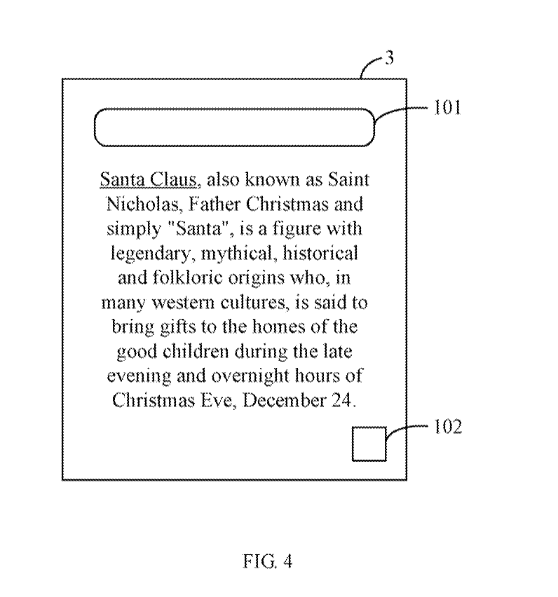

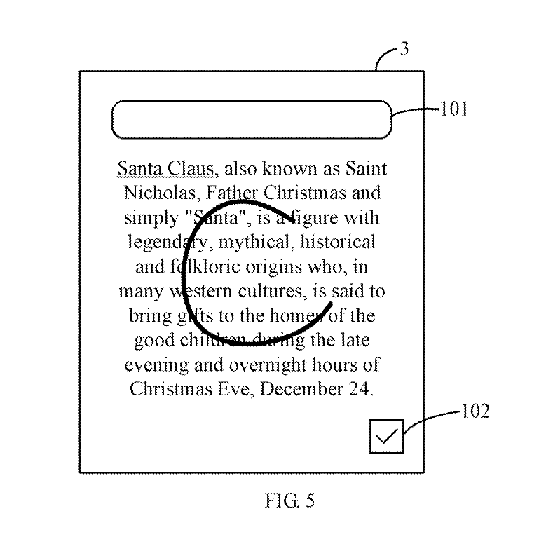

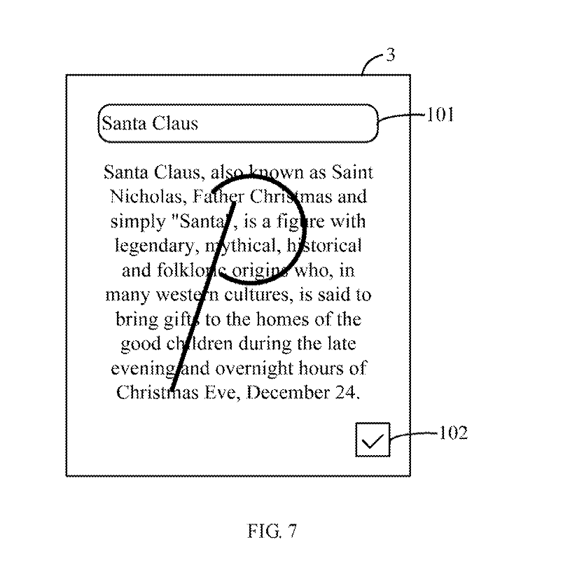

In step S2, the recognition module 202 uses the handwriting recognition system 4 to acquire handwritten data that is input by the user via the touch screen 3 and recognized by the handwriting recognition system 4. In one embodiment, the text editing system 20 may display a handwriting option 102 as shown in FIG. 4 on the touch screen 3. The recognition module 202 runs the handwriting recognition system 4 when the user selects the handwriting option 102, and the recognition module 202 closes the handwriting recognition system 4 when the handwriting option 102 is unselected by the user. The handwritten data may be a letter or a number input from the touch screen 3, such as a letter “C” input from the touch screen 3 as shown in FIG. 5, or a letter “P” input from the touch screen 3 as shown in FIG. 7. The handwriting system 4 may use a number of common handwriting databases and algorithms to interpret the handwritten data.

In step S3, the performing module 203 performs a predetermined editing operation corresponding to the recognized handwritten data on the target text, and closes the handwriting recognition system 4 according to user requirements. The editing operation may be a cut operation, a copy operation, or a paste operation.

Referring to FIG. 4, the touch screen 3 displays a text, an input box 101, and the handwriting option 102. The input box 101 is used for receiving one or more characters input by the user. The acquisition module 201 acquires a target text, such as an underlined target text “Santa Claus” that is selected by the user. In FIG. 5, the recognition module 202 runs the handwriting recognition system 4 when the handwriting option 102 is selected by the user, and acquires a letter “C” that is the recognized handwritten data from the handwriting recognition system 4. If the letter “C” is input from the touch screen 3 and corresponds to the copy operation, the performing module 203 copies the target text “Santa Claus” to generate a duplicate text “Santa Claus,” and closes the handwriting recognition system 4 when the handwriting option 102 is unselected by the user.

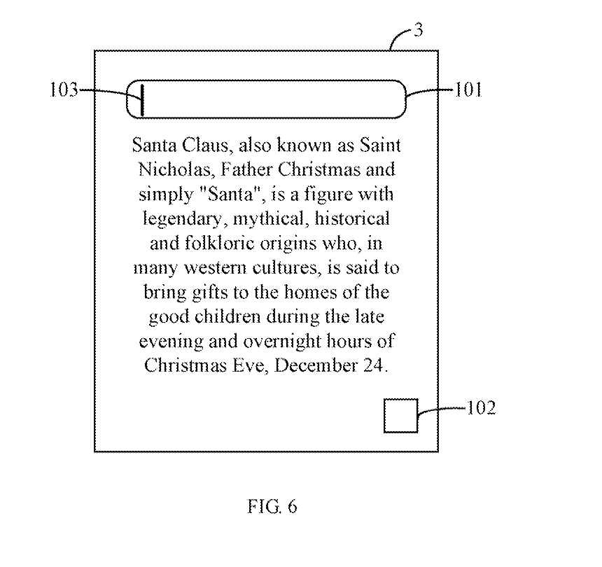

In FIG. 6, a text cursor 103 is positioned in the input box 101 indicating that the input box 101 can receive input characters. In FIG. 7, the recognition module 202 runs the handwriting recognition system 4 when the handwriting option 102 is selected by the user, and acquires a letter “P” that is the recognized handwritten data from the handwriting recognition system 4. If the letter “P” is input from the touch screen 3 and corresponds to the paste operation, the performing module 203 inserts the duplicate text “Santa Claus” in the input box 101 where the text cursor 103 is positioned, and closes the handwriting recognition system 4 when the handwriting option is unselected by the user.

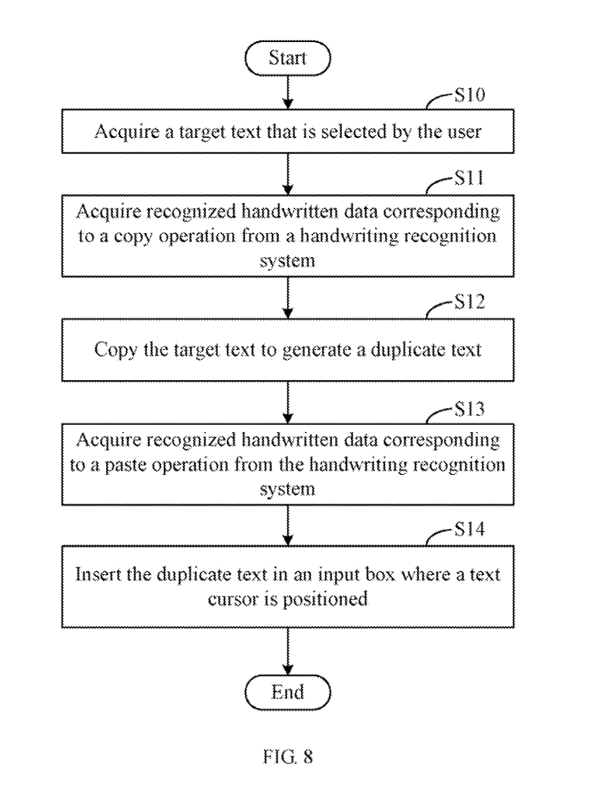

FIG. 8 is a flowchart illustrating an example of the text editing operations corresponding to FIGS. 4-7. Depending on the embodiment, additional steps may be added, others removed, and the ordering of the steps may be changed.

In step S10, the acquisition module 201 acquires the target text that is selected by the user, as shown in FIG. 4, and the recognition module 202 runs the handwriting recognition system 4 when the handwriting option 102 is selected by the user.

In step S11, the recognition module 202 acquires recognized handwritten data (e.g., the letter “C”) corresponding to the copy operation from the handwriting recognition system 4, such as shown in FIG. 5.

In step S12, the performing module 203 copies the target text to generate a duplicate text.

In step S13, the recognition module 202 acquires recognized handwritten data (e.g., the letter “P”) corresponding to the paste operation from the handwriting recognition system 4, such as shown in FIG. 7.

In step S14, the performing module 203 inserts the duplicate text in the input box 101 where the text cursor 103 is positioned, and closes the handwriting recognition system 4 when the handwriting option is unselected by the user.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone, comprising:
a touch screen;
a storage system;
at least one processor;
one or more programs stored in the storage system and executed by the at least one processor, the one or more programs comprising:
an acquisition module that acquires a target text that is displayed on the touch screen and selected by a user via the touch screen;
a recognition module that acquires handwritten data that is input by the user via the touch screen and recognized by a handwriting recognition system of the mobile phone;
a performing module that performs a predetermined editing operation corresponding to the handwritten data on the target text.

2. The mobile phone of claim 1, wherein the touch screen displays a handwriting option operable to run or close the handwriting recognition system according to selection of the handwriting option.

3. The mobile phone of claim 2, wherein the recognition module further runs the handwriting recognition system when the handwriting option is selected.

4. The mobile phone of claim 2, wherein the performing module further closes the handwriting recognition system when the handwriting option is unselected.

5. The mobile phone of claim 1, wherein the editing operation is a cut operation, a copy operation, or a paste operation.

6. A method for editing text using a mobile phone comprising a touch screen, the method comprising:
(a) acquiring a target text that is displayed on the touch screen of the mobile phone and selected by a user via the touch screen;
(b) acquiring handwritten data that is input by the user via the touch screen and recognized by a handwriting recognition system of the mobile phone;
(c) performing a predetermined editing operation corresponding to the handwritten data on the target text.

7. The method of claim 6, wherein the touch screen displays a handwriting option operable to run or close the handwriting recognition system according to selection of the handwriting option.

8. The method of claim 7, wherein the step (b) further comprises:
running the handwriting recognition system when the handwriting option is selected.

9. The method of claim 7, wherein the step (c) further comprises:
closing the handwriting recognition system when the handwriting option is unselected.

10. The method of claim 6, wherein the editing operation is a cut operation, a copy operation, or a paste operation.

11. A non-transitory storage medium storing a set of instructions, the set of instructions capable of being executed by a processor of a mobile phone comprising a touch screen, causes the mobile phone to execute a method for editing text, the method comprising:
(a) acquiring a target text that is displayed on the touch screen of the mobile phone and selected by a user via the touch screen;
(b) acquiring handwritten data that is input by the user via the touch screen and recognized by a handwriting recognition system of the mobile phone;
(c) performing a predetermined editing operation corresponding to the handwritten data on the target text.

12. The storage medium of claim 11, wherein the touch screen displays a handwriting option operable to run or close the handwriting recognition system according to selection of the handwriting option.

13. The storage medium of claim 12, wherein the step (b) further comprises:
running the handwriting recognition system when the handwriting option is selected.

14. The storage medium of claim 12, wherein the step (c) further comprises:
closing the handwriting recognition system when the handwriting option is unselected.

15. The storage medium of claim 11, wherein the editing operation is a cut operation, a copy operation, or a paste operation.
